(19) United States
(12) Patent Application Publication
(10) Pub. No.: US 2023/0222189 A1
(43) Pub. Date: Jul. 13, 2023

(54) PERFORMANCE OF DIFFERENT ACTIONS AT DEVICE BASED ON SUCCESS OR FAILURE OF SUBSEQUENT AUTHENTICATION WITHIN THRESHOLD TIME AFTER REPEATED AUTHENTICATION FAILS

(71) Applicant: Lenovo (Singapore) Pte. Ltd., Singapore (SG)

(72) Inventors: Robert J. Kapinos, Durham, NC (US); Scott Li, Cary, NC (US); Russell Speight VanBlon, Raleigh, NC (US); Robert James Norton, JR., Raleigh, NC (US)

(21) Appl. No.: 17/574,436

(22) Filed: Jan. 12, 2022

(51) Int. Cl. G06F 21/31

(52) U.S. Cl. CPC G06F 21/31; G06F 2221/2139; G06F 2221/2113

(57) ABSTRACT

In one aspect, a device may include at least one processor and storage accessible to the processor. The storage may include instructions executable by the processor to identify a threshold amount of time related to authentication failure based on an activity for which the device is currently being used and at least one method of authentication to be used for authenticating a user while the user performs the activity. The instructions may also be executable to take at least a first action based on an interruption that prevents repeated authentication not exceeding the threshold amount of time, and to take at least a second action based on successful authentication resuming subsequent to the interruption but within the threshold amount of time. The instructions may also be executable to take at least a third action based on the interruption exceeding the threshold amount of time.

### FIELD

The disclosure below relates to technically inventive, non-routine solutions that are necessarily rooted in computer technology and that produce concrete technical improvements. In particular, the disclosure below relates to techniques for performance of different actions at a device based on success or failure of subsequent authentication within threshold time after repeated authentication fails.

### BACKGROUND

As recognized herein, many computers and networks are moving away from a single authentication like username and password entry to gain access to a set of digital resources since that is relatively insecure. For instance, as recognized herein a user might login to gain access to a certain document but then walk away from their device, leaving the device unattended so that nefarious actors might come up to the device and make unauthorized changes to the document or even make an illicit copy of the document itself unbeknownst to the user. As also recognized herein, username and password entry for authentication is in general much less secure than other forms of authentication as it is greatly susceptible to hacking of the document or other electronic resource from remote locations, data leaks of the login credentials themselves, etc. As further recognized herein, these technological problems are particularly acute in high-security settings. However, there are currently no adequate solutions to the foregoing computer-related, technological problems.

### SUMMARY

Accordingly, in one aspect a device includes at least one processor and storage accessible to the at least one processor. The storage includes instructions executable by the at least one processor to identify a threshold amount of time related to authentication failure, where the identification of the threshold amount of time is based on an activity for which the device is currently being used and/or at least one method of authentication to be used for authenticating a user while the user performs the activity. Based on an interruption that prevents repeated authentication not exceeding the threshold amount of time, the instructions are executable to take at least a first action. Based on successful authentication resuming subsequent to the interruption but within the threshold amount of time, the instructions are executable to take at least a second action different from the first action. Based on the interruption exceeding the threshold amount of time, the instructions are executable to take at least a third action different from the first and second actions.

In certain examples, repeated authentication may include continuous authentication and/or periodic authentication such as periodic authentication at one or more regular time intervals.

Also in certain examples, the instructions may be executable to identify the threshold amount of time based on the activity for which the device is currently being used and a security level associated with the activity.

In various example implementations, the first action may include refraining from providing a notification to a person regarding the interruption, accepting changes to a file or other data but not saving the changes to persistent storage as part of a current version of the file, accepting actions taken in relation to the file but not saving the actions to persistent storage, indicating the changes in a first log separate from the file, and/or indicating the actions in a second log separate from the file.

Also in various example implementations, the interruption may be a first interruption and the second action may include saving the changes to persistent storage as part of the current version of the file, saving the actions to persistent storage, indicating the first interruption in a third log separate from the file, and/or determining whether a second interruption occurring subsequent to the first interruption exceeds the threshold amount of time.

Still further, in some example implementations the third action may include prompting the user to authenticate themselves using a different method of authentication to save the changes, prompting the user to authenticate themselves using a different method of authentication to save the actions, locking the user out of the device and prompting the user to authenticate themselves using a different method of authentication to allow the user access to the device again, locking the user out of the file and prompting the user to authenticate themselves using a different method of authentication to allow the user access to the file again, indicating in a fourth log the first interruption as exceeding the threshold amount of time, performing another action that otherwise occurs based on authentication failure, marking the change as associated with authentication failure, marking the action as associated with authentication failure, and/or providing the notification to the person regarding the first interruption where the person may be different than the user.

Still further, if desired the instructions may be executable to save the changes to persistent storage as part of the current version of the file responsive to user authentication subsequent to performance of the third action and using the different mode of authentication, and/or to save the actions to persistent storage responsive to user authentication subsequent to performance of the third action and using the different mode of authentication.

Also in certain examples, repeated authentication may involve authenticating a user based on input other than a password associated with the user.

In another aspect, a method includes identifying a threshold amount of time based on an activity for which a device is currently being used and/or at least one mode of authentication to be used for authenticating a user while the user performs the activity. Based on an interruption that prevents repeated authentication not exceeding the threshold amount of time, the method includes taking at least a first action. Based on the interruption exceeding the threshold amount of time, the method includes taking at least a second action different from the first action.

Additionally, in some example implementations the method may include, based on successful authentication resuming subsequent to the interruption but within the threshold amount of time, taking at least a third action different from the first and second actions. The interruption may be a first interruption and the third action may include saving changes to a file to persistent storage as part of a current version of the file, saving actions taken in relation to the file to persistent storage, indicating the first interruption in a log separate from the file, and/or determining whether a second interruption occurring subsequent to the first interruption exceeds the threshold amount of time.

If desired, in various examples the first action may include refraining from providing a notification to a person regarding the interruption, accepting changes to a file but not saving the changes to persistent storage as part of a current version of the file, accepting actions taken in relation to the file but not saving the actions to persistent storage, indicating the changes in a first log separate from the file, and/or indicating the actions in a second log separate from the file.

Also if desired, in certain examples the second action may include prompting the user to authenticate themselves using a different mode of authentication to save the changes, prompting the user to authenticate themselves using a different mode of authentication to save the actions, locking the user out of the device and prompting the user to authenticate themselves using a different mode of authentication to allow the user access to the device again, locking the user out of the file and prompting the user to authenticate themselves using a different mode of authentication to allow the user access to the file again, indicating in a fourth log the interruption as exceeding the threshold amount of time, performing another action that otherwise occurs based on authentication failure, marking the change as associated with authentication failure, marking the action as associated with authentication failure, and/or providing the notification to the person regarding the interruption where the person may be different than the user.

In still another aspect, at least one computer readable storage medium (CRSM) that is not a transitory signal includes instructions executable by at least one processor to identify a threshold amount of time based on an activity for which a device is currently being used and at least one method of authentication to be used for authenticating a user while the user performs the activity. Based on an interruption that prevents repeated authentication not exceeding the threshold amount of time, the instructions are executable to take at least a first action. Based on the interruption exceeding the threshold amount of time, the instructions are executable to take at least a second action different from the first action.

Additionally, in some examples based on successful authentication resuming subsequent to the interruption but within the threshold amount of time, the instructions may be executable to take at least a third action different from the first and second actions.

Still further, in certain example implementations the first action may involve reflecting changes to an electronic document on a display but not saving the changes to persistent storage as part of a current version of the electronic document, while the second action may involve reauthenticating the user to save the changes to persistent storage as part of the current version of the electronic document.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates example logic in example flow chart format that may be executed by a device consistent with present principles;

FIGS. 4-9 show various example graphical user interfaces (GUIs) that may be presented on a display at various stages during repeated authentication or authentication failure consistent with present principles; and

FIG. 10 shows an example GUI that may be presented on a display to configure one or more settings related to authentication consistent with present principles.

### DETAILED DESCRIPTION

Among other things, the detailed description below discusses aspects related to repeated authentication, such as continuous authentication. Repeated authentication may allow for higher security and robust audit trails. Repeated authentication may be maintained with sufficient uptime, but because interruptions might occur through no fault of the authenticating user themselves, the disclosure below discusses fault tolerance techniques for, e.g., sometimes less-than-critical authentication failures in order to improve usability and functionality of these electronic systems and the associated devices themselves. This may help so that the authentication system need not immediately terminate the user's work upon authentication failure, helping to avoid an unwanted “security blinking” effect, while also helping to avoid data loss for data unsuccessfully entered during short authentication outages.

Accordingly, actions to take during certain authentication outages are discussed below to allow the user to continue to work during those outages. These actions may work in parallel with other methods of handling failure-of-continuity breaks. Then if a “large” continuity break or actual notable loss of authentication is found, other methods of marking and invalidating data may be used.

With that in mind, first a threshold may be set as to how long a continuity interruption can exist without triggering a higher-level authentication failure event. The threshold may be based on the activity underway, and the authentication method used. For example, the activity type may be editing a word processing document and an authentication gap may be “tolerated” as long as the user is not actively typing anything.

As examples of authentication type and corresponding gaps, continuous authentication using a camera might accept an 800 ms gap, while speech detection might accept a 10 or 20 second gap.

Then as long as any gap in repeated/continuous authentication does not exceed the gap threshold, the system may refrain from notifying the user, accept changes and actions (but not save them), and/or keep a running log of changes and actions made while the gap is happening.

Then if the gap in authentication ends within the allowable time, the system may commit the changes and actions as authenticated, note that there was an “unimportant” gap in any security logs, and/or reset the gap timer to the same as if authentication had been continuous.

Then if the gap in authentication does not end within the allowable time, the system may take other action such as prompting the user for a third, high security credential to commit any changes made during the gap time, saving the expiry in the security logs, doing other actions that would occur upon continuous authentic failure, and/or doing any marking of data as “low security” as might otherwise be done for non-continuous authentication/authentication failures.

Examples of types of authentication that may be used consistent with present principles include various types of biometric authentication, attention tracking, presence detection and/or activity-based authentication (e.g., a user detected as actively typing on a keyboard), geofencing, radar-base authentication, audio-based authentication, touch-based authentication, and even joint/sensor fusion authentication like facial recognition in combination with presence detection through detecting active typing on a keyboard.

Accordingly, consistent with present principles, an authentication system may establish the service interruptions that are allowable in repeated/continuous authentication situations both dynamically and statically. Service interruptions that fall within the allowable guidelines may be ignored. Action may be taken after the fact on interruptions that are marginal. Other authentication failures that are disallowed by the guidelines may be passed to the other security failure mechanisms. In this way, in at least some examples a gap may be allowed to occur if it is less than the relevant threshold so that the system appears to the user to be acting as if the gap is not occurring, but severe “destructive activities” may still not be allowed to occur or may at least be mitigated.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM, or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

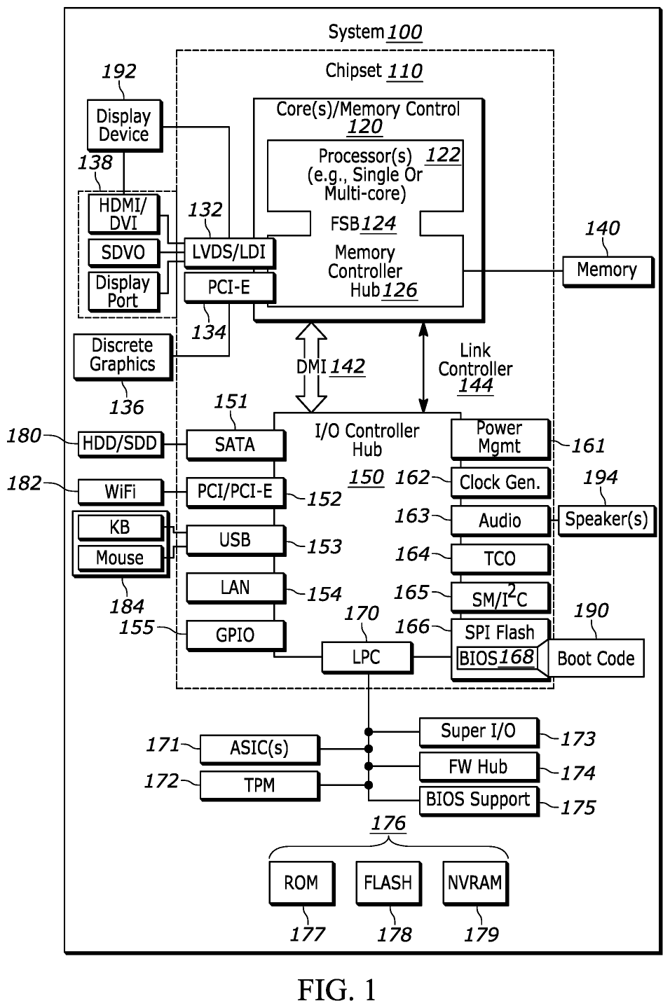

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122.

Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Other biometric sensors and other devices for authentication consistent with present principles may also be included on the system 100, such as a fingerprint reader for example.

Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

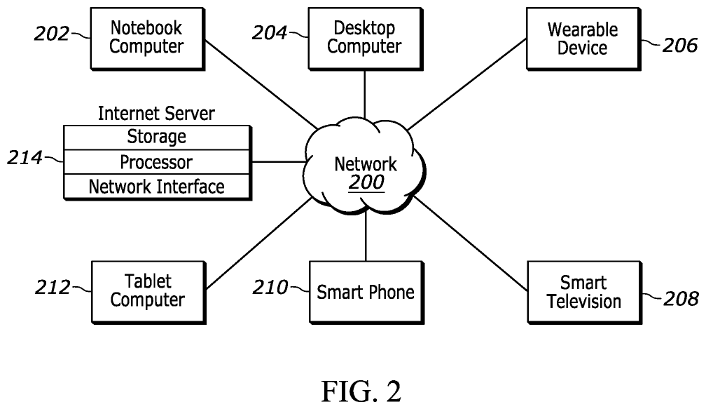

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles (e.g., to perform repeated authentication).

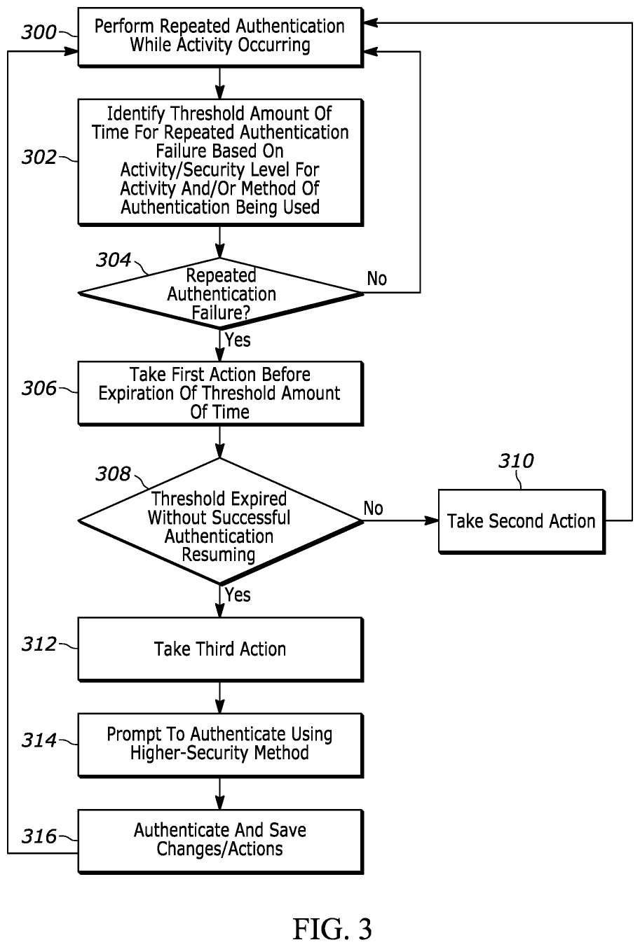

Before going into detail on FIG. 3, first suppose that an end-user is operating within an environment in which robust digital security should be used to ensure the integrity of confidential information, digital data, non-public company projects, etc. Part of ensuring such digital security might entail, for example, robust digital security for a word processing document that is being drafted by one or more people and that might contain sensitive technological project information. Thus, the company or other entity for which the end-user works and for which the word processing document is being drafted as part of a company-driven effort may wish to use repeated authentication while the end-user is drafting the document, editing the document, and taking other actions in relation to the document such as saving the document to a new file location, re-saving an updated version of the document to a current file location, making an additional copy of the document, sending the document via email to someone else within the company, etc.

As such, repeated authentication may include continuous authentication while the document is open and/or while user input is being provided to the document. Additionally, or alternatively, repeated authentication might include periodic authentication, such as periodic authentication that occurs at one or more regular time intervals.

Whether continuous or periodic authentication is used in a given instance may depend not only on system administrator-configured settings but also based on the type of authentication being used. For example, “continuous” voice identification (ID) authentication might be executed to identify the user based on voice input that the user provides to a microphone and on which biometric voice identification is then executed, so long as the user speaks more or less continuously. As another example, periodic authentication might be used in the context of facial recognition by using input from a camera that is then used to identify the user since only a certain number of frames per second may actually be provided by the camera, essentially acting as micro-snapshots in time. Facial recognition might also be periodic in the sense that the facial recognition software might only use a subset of the images streamed from the camera in the first place (e.g., analyze two frames per second (fps) where 30 fps are actually being provided by the camera).

But regardless of whether continuous or periodic authentication is used, note that this goes beyond a single-time authentication for the end-user to get past the “gate” and have unlimited access to the company's electronic system(s) at large or the particular word processing document at issue at least until they leave or logout, which might otherwise occur using a username/password login combination or even a single facial recognition or other biometric ID authentication or other type of authentication. Those single-time authentications might still be used in combination, but consistent with present principles repeated authentication for a higher level of security may be used either way to provide even greater and robust digital security. This may ensure that, for example, a hacker has not logged in remotely using a username/password combination or other single-time authentication (such as spoofing the face of the end-user with a photograph for a single-time facial ID) and then has unfettered access to the company's electronic systems or relevant word processing document in particular. As another example, this may also help in instances where the authorized end-user gets up and walks away from their desk while editing the word processing document or otherwise diverts their attention elsewhere so that a nefarious actor may be allowed to see or control the device the end-user was using while the end-user is still logged in but has their attention diverted elsewhere.

However, as further recognized below, repeated authentication still might experience interruptions through no fault of the end-user themselves. For example, there may be bandwidth limitations, breaks in communication, or other electrical glitches between a biometric ID sensor such as a camera or microphone and the processor itself that is performing the biometric ID. Or the sensor or other device might temporarily fail, fail altogether, or be performing an update during which it cannot be used. Or maybe an object obstructs a camera being used for facial recognition/ID so facial ID cannot be performed, or too much ambient noise is being picked up by a microphone being used for voice recognition/ID so that voice ID cannot be performed. Absent the principles below, while repeated authentication is unavailable the end-user might be locked out for security purposes from making changes or taking other actions in relation to the word processing document that is being drafted, such as saving a newer version of the document with updates.

With the foregoing in mind, reference is now made to the example logic of FIG. 3. This logic may be executed by a device such as the system 100, an end-user's personal device (e.g., laptop, smartphone, or other device) to provide access to local device resources or even locally-executing software applications (apps) to provide access to specific function of those apps, a networked device (e.g., to provide cloud access), and/or a remotely-located server alone or in any appropriate combination consistent with present principles. Also note that while the logic of FIG. 3 is shown in flow chart format, other suitable logic may also be used. Also note in relation to the description of FIG. 3 that the word processing document example from above may be referenced to further illustrate.

Beginning at block 300, the device(s) may begin performing repeated authentication while an activity is occurring, such as editing the word processing document from above or even changing network configuration settings or performing other sensitive activities. From block 300 the logic may then move to block 302.

At block 302 the device may identify a threshold amount of time related to authentication failure, where the identification of the threshold amount of time may be based on an activity for which the device is currently being used (and, e.g., the corresponding security level associated with the activity as may be configured by a system admin) and/or at least one method/mode of authentication to be used for authenticating the user while the user performs the activity

Thus, in example implementations the threshold amount of time may be longer than the regular interval otherwise used for the particular type of repeated authentication itself. In this respect the threshold amount of time may be dynamic in that the threshold may vary as the regular interval varies, depending on the type of authentication being used. Moreover, the regular interval may vary as dependent not just on the limitations of the method of authentication itself but also based on configuration by a system administrator (admin) or other person. Thus, whatever the regular interval, once identified by the device, a different (longer) threshold amount of time may be selected by the device based on that. So, for example, if facial recognition were used and the regular interval was one authentication every one thirtieth of a second based on a camera frame rate of 30 frames per second being provided (or per system administrator configuration, one authentication every half second), the system administrator or other person may correlate that method of authentication and/or regular interval to a desired threshold amount of time greater than one thirtieth of a second (or greater than a half second) in a relational database accessible to the device for ultimately identifying a certain threshold amount of time at block 302.

This relational database may also indicate different thresholds to apply based on other criteria as well. For example, the threshold amount of time may vary based on the activity being performed and the corresponding desired security level that the system admin wants associated with that activity. Taking the word processing document example from above, word processing in general may be an activity associated in the relational database with one threshold amount of time when facial recognition is used and another threshold amount of time when another method of authentication is used (e.g., also depending on the desired security level for protecting changes and other activities performed in relation to word processing).

What is more, in some specific examples, the type or classification for the specific document (or user activity) at issue may also be used so that different types of word processing documents may be associated with different levels of security and hence different thresholds. For example, any word processing document classified as pertaining to a business purpose or sensitive company project may be associated in the relational database with one threshold amount of time, while a longer threshold amount of time (thus having lesser security) may be associated in the relational database with documents classified as pertaining to personal or non-business purposes, even if both thresholds still pertain to the facial recognition method of authentication. Likewise, still other threshold amounts of time might be indicated in the relational database for accessing different types of sensitive device hardware, different types of network resources or cloud storage locations, etc. even if facial recognition is still the method of authentication being used for each.

Thus, note more generally that the relational database(s) may include these threshold entries for each method of authentication to be used (and/or given combination of factors, including activity type, specific activity/document, security level involved, etc.) as may be configured by a system admin depending on the desired security level. Entries for different thresholds may even be configured in the relational database for each combination of plural methods of repeated authentication that might be required for concurrent use in certain examples for even greater security as may be desired while the user performs a given activity. For example, keyboard input-based presence detection may be used in combination with facial recognition for a highly-secure user activity, and so a particular threshold amount of time may be set by the system admin based on those methods of authentication being used for that activity.

Still in reference to FIG. 3, from block 302 the logic may move to decision diamond 304. At diamond 304 the device may determine whether a repeated authentication failure has occurred, such as due to a break in network connection or camera obstruction or other factor as referenced above. A negative determination may cause the logic to revert back to block 300 and proceed therefrom to continue repeated authentication of the user while the user performs the same or a different activity.

However, an affirmative determination may instead cause the logic to proceed to block 306. At block 306 the device may take at least one first action based on the interruption to the repeated authentication but prior to the length of the interruption/failure exceeding the relevant threshold amount of time as identified at block 302. The first action may include refraining from providing a notification (e.g., email) to a person such as a system admin regarding the interruption (e.g., as might otherwise occur upon repeated authentication failure), accepting changes to a file (or other data such as system data and distributed data the system might be accessing) like the word processing document above but not saving the changes to persistent storage as part of a current version of the file, accepting/executing actions taken in relation to the file but not saving the actions to persistent storage, indicating the changes in a first log separate from the file, and/or indicating the actions in a second log separate from the file. The first and second logs themselves may be the same or may be different.

From block 306 the logic may then proceed to decision diamond 308. At diamond 308 the device may determine whether the threshold amount of time has expired without successful authentication of the user resuming according to the method of repeated authentication that was already being used. Based on successful authentication resuming subsequent to the interruption but within the threshold amount of time, the logic may move to block 310 where the device may take at least one second action different from the first action. The second action may include saving the changes to persistent storage as part of the current version of the file (e.g., changes made during the interruption itself), saving the actions to persistent storage or otherwise executing the actions (e.g., actions taken during the interruption itself), indicating the initial interruption determined at diamond 308 in a third log separate from the file being changed/edited (where the third log may be the same as or different from the first and/or second log), and/or determining whether a second, subsequent interruption occurring subsequent to the first interruption exceeds the threshold amount of time (which might occur responsive to the first interruption ending before expiration of the threshold amount of time). Thus, note that from block 310 the logic may proceed back to block 300 for determining whether the second interruption has occurred. However, further note that in other examples the logic may revert from block 310 back to diamond 308 while the initial/first interruption is still ongoing to proceed therefrom.

Then once the device determines at diamond 308 that the threshold amount of time has expired during the initial/first interruption without successful repeated authentication resuming, the logic may move to block 312. At block 312, one or more third actions may be taken based on the interruption exceeding the threshold amount of time.

The third action(s) may be different from the first and second actions and, as such, may include prompting the user visually, audibly, haptically, etc. to authenticate themselves using a different method of authentication to save the changes they've made during the interruption, prompting the user to authenticate themselves using a different method of authentication to save the actions they've taken during the interruption, locking the user out of the device and prompting the user to authenticate themselves using a different and possibly higher-security method of authentication to allow the user access to the device, file, resource, etc. again, locking the user out of the file and prompting the user to authenticate themselves using a different and possibly higher-security method of authentication to allow the user access to the file again, indicating in a fourth log the relevant interruption as exceeding the threshold amount of time, performing another action that otherwise may occur based on authentication failure (e.g., proxying action related to authentication failure to another program, to the guest operating system, or to another software entity for which the authentication is being performed), marking the change made during the interruption as associated with authentication failure (e.g., in the fourth log and/or file itself), marking the action as associated with authentication failure (e.g., in the fourth log and/or file itself), providing a notification/alert such as an email to a person regarding the first interruption such as a system administrator or the user themselves. Note here that the fourth log may be the same as or different from the first, second, and/or third logs. Also note that these logs may be stored at the local device itself, in cloud storage, or any other suitable persistent storage location where the system admin or other people may go later to view the logs for analysis.

Still in reference to FIG. 3, from block 312 the logic may then proceed to block 314. At block 314 the device may prompt the user to authenticate themselves again using a higher-security method of authentication. Thus, a ranking of methods of authentication from high to low may be accessed to do so, where the ranking may also be established by the system admin. For example, keyboard presentence detection may be ranked lower than facial recognition, while facial recognition may be ranked lower than iris recognition.

Then responsive to valid user input to authenticate themselves, the logic may proceed to block 316 to perform the authentication itself and save the changes (e.g., to persistent storage as part of the current version of the file) or save/perform the other actions the user attempted during the relevant interruption. The user's changes and/or actions may also be marked in any security logs as being valid. From block 316 the logic may then proceed back to block 300 if desired to proceed again therefrom.

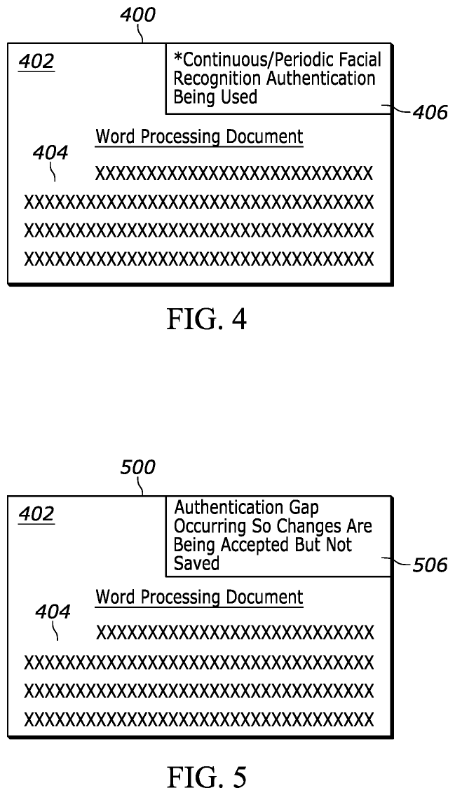

FIGS. 4-9 further illustrate, again using the word processing document example from above. Beginning with FIG. 4, a graphical user interface (GUI) 400 is shown that includes a word processing document 402 into which an end-user has entered text 404. As also shown in FIG. 4, the GUI 400 may include an indication 406 that includes a star icon and text indicating that repeated authentication via facial recognition is being used to authenticate the user while the user types additional text into the document 402. Thus, it is to be understood that the GUI 400, including the indication 406, may be presented during execution of block 300 of FIG. 3 as described above.

Then, responsive to block 306 from above being executed and/or as part of block 306 being executed, the GUI 400 may change to a GUI 500 as shown in FIG. 5. The GUI 500 still includes the word processing document 402 with its text 404. As also shown in FIG. 5, the GUI 500 may include an indication 506 that includes a different icon (not shown) and text indicating that repeated authentication has now failed (and therefore a “gap” in repeated authentication is occurring). As also shown in FIG. 5, the indication 506 also indicates that changes to the document 402 are being accepted and thus visually reflected on the document 402 as the document is presented on the user's device's display, but that the changes are not being saved to persistent storage as part of a current version of the electronic document 402 itself.

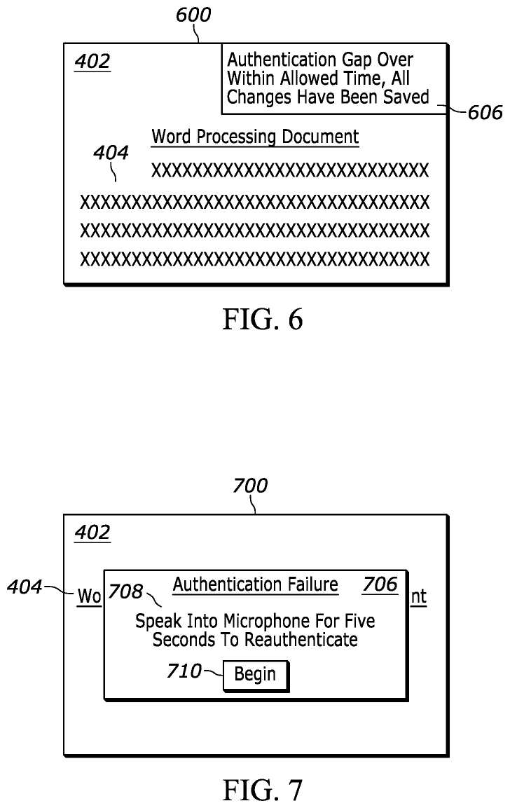

Thereafter, responsive to block 310 from above being executed and/or as part of block 310 being executed, the GUI 500 may change to a GUI 600 as shown in FIG. 6. The GUI 600 still includes the word processing document 402 with its text 404 (e.g., possibly including accepted but not saved text that has been entered since repeated authentication was interrupted). As also shown in FIG. 6, the GUI 600 may include an indication 606 that includes yet another different icon (not shown) and text indicating that repeated authentication has now resumed (and therefore the gap in repeated authentication is over since the user has been reauthenticated). As further shown in FIG. 6, the indication 606 also indicates that previously-accepted but not saved changes to the document 402 have now been saved to persistent storage as part of the current version of the electronic document 402 as well as any additional changes that might be made (e.g., entering additional text, editing already-entered text, etc.).

However, note that if instead block 312 or block 314 is reached, responsive thereto and/or as part of either block being executed the GUI 500 may instead change to a GUI 700 as shown in FIG. 7. The GUI 700 still includes the word processing document 402 possibly with parts of the text 404 also presented or possibly with none of the text 404 presented owing to the authentication gap and hence potential need to secure the data. As also shown in FIG. 7, the GUI 700 may include an overlay window 706 that obstructs some or all of the text 404 but also includes its own text indicating a repeated authentication failure. The window 706 may also include instructions 708 for the user to speak into the microphone for five seconds to reauthenticate themselves as a more-secure level of authentication to gain access to the document 402 again for making changes and taking other actions in relation to the document. Thus, the user may either simply begin speaking to reauthenticate themselves or, in some examples, may first select the selector 710 (e.g., using touch or cursor input) to begin a five-second timer for speaking for reauthentication.

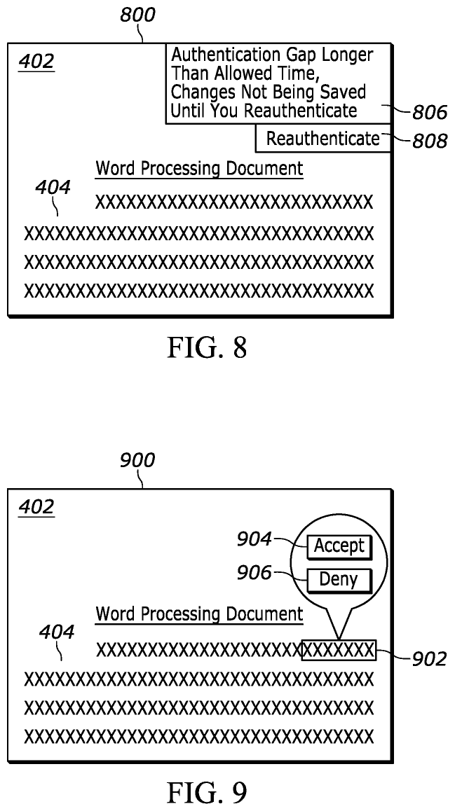

As an alternative to the GUI 700, possibly for a document or activity involving a relatively lower security level, the GUI 800 of FIG. 8 might be presented in some instances based on block 312 or block 314 being reached. Here again the GUI 800 may still include the word processing document 402 and some or all of the text 404 as would otherwise be presented based on repeated authentication occurring as it should. But as also shown in FIG. 8, the GUI 800 may include an indication 806 that includes text indicating that repeated authentication has now failed for the relevant threshold amount of time (and therefore a gap in repeated authentication is occurring). As also shown in FIG. 8, the indication 806 may also indicate that changes to the document 402 are not being saved to persistent storage (e.g., whether still accepted or not depending on implementation since in some instances changes may no longer even be accepted responsive to the gap occurring).

As also shown in FIG. 8, the indication 806 may be accompanied by a selector 808 that is presented as part of the GUI 800. The selector 808 may be selected to begin a process for the user to reauthenticate themselves. For example, selection of the selector 808 may cause the window 706 to be overlaid on the document 402 as part of the GUI 800. Or selection of the selector 808 may simply command the device to attempt reauthentication again at that point using the same method/mode of authentication that was already being used for the repeated authentication that failed.

Then once the user has been reauthenticated through either of the GUIs 700 or 800, the GUI 900 of FIG. 9 may be presented. Here again the GUI 900 may include the word processing document 402 and the text 404 so that the user may make changes to and save the document 402 with the changes. However, further note that responsive to the user being reauthenticated and granted access to the document again and thus provided the ability to again save changes made thereto, the GUI 900 may include a highlight box 902 that surrounds text that was added or edited while the authentication gap was occurring. This may be useful to help the user ensure integrity of that text. Thus, to accept the addition or change and save it as part of the current version of the document 402, the user may select selector 904. However, if for some reason the user wishes to deny the addition or change and revert to a most-recently saved version of the document (or specific text itself) from prior to the authentication gap, then selector 906 may be selected instead.

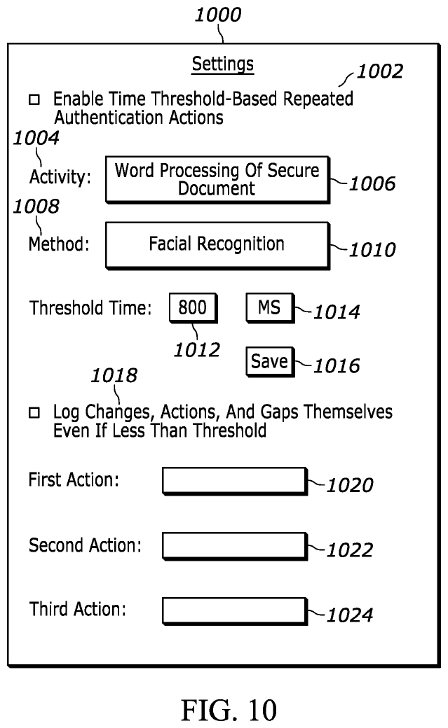

Continuing the detailed description in reference to FIG. 10, it shows another example GUI 1000 that may be presented on the display of the device undertaking the logic of FIG. 3, the display of an end-user's own client device, or another display of another device such as a system administrator's device. The GUI 1000 may be a settings GUI that may be presented to set or enable one or more settings of a device or repeated authentication system to operate consistent with present principles. For example, the GUI 1000 may be reached by navigating a main settings menu of the device or its operating system, a hardware settings menu, a settings menu for an application being used by the user (e.g., word processing application), or a settings menu for a dedicated authentication application that is being used for repeated authentication consistent with present principles. Also note that in the example shown, each option discussed below may be selected by directing touch or cursor input to the respective check box adjacent to the respective option.

As shown in FIG. 10, the GUI 1000 may include an option 1002 that may be selectable a single time to set or configure the device to undertake present principles in multiple future instances, such as executing the functions described above in reference to FIGS. 4-9 and executing the logic of FIG. 3 for different digital activities in the future.

As also shown in FIG. 10, the GUI 1000 may include a section 1004 presenting a selector 1006 that may be selected to present a drop-down menu, pop-up menu, or other type of menu from which a particular activity may be selected (and in some examples, a particular file to which the activity pertains may be selected for configuration of authentication settings for that particular file). Here again the example activity that has been selected is editing a secure word processing document (as indicated on the face of the selector 1006) but other activities may also be selected such as saving items to secure cloud storage, managing network infrastructure, sending communications over a LAN, etc.

The GUI 1000 may further include a section 1008 presenting a selector 1010 that may be selected to present a drop-down menu, pop-up menu, or other type of menu from which a particular method/mode of repeated authentication to use may be selected for the activity already selected via the selector 1006. Here again the example method is facial recognition, but other methods may also be selected.

Then after the selections above have been made, a threshold amount of time to use for the activity and authentication method combination that has already been selected may be established. To do so, the user may use a hard or soft keyboard to enter a number into number entry box 1012 and select or input a time increment to associate with the number via box 1014. In the present example, the threshold amount of time has been set to eight hundred milliseconds. Then once the user or system administrator's preferences have been provided for that activity/authentication method combination, the save selector 1016 may be selected to save those preferences and associate them with the specified threshold amount of time (e.g., in a relational database as described above). The user or admin may then repeat the process for other combinations.

Additionally, if desired in some examples the GUI 1000 may include an option 1018 that may be selectable to specifically set or configure the device/system to log changes, actions, and repeated authentication gaps in one or more logs as described above (e.g., even if the associated gap is less than the relevant threshold itself).

Still further, the GUI 1000 may include a selector 1020 that may be selected to present a drop-down menu, pop-up menu, or other menu from which one or more first actions may be selected for execution at block 306 as described above. Likewise, selector 1022 may be selected to present a similar menu from which one or more second actions may be selected for execution at block 310 as described above. Additionally, selector 1024 may be selected to present a similar menu from which one or more third actions may be selected for execution at block 312 as described above.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged, or excluded from other embodiments.

What is claimed is:

1. A device, comprising:
at least one processor; and
storage accessible to the at least one processor and comprising instructions executable by the at least one processor to:
identify a threshold amount of time related to authentication failure, the identification of the threshold amount of time being based on one or more of: an activity for which the device is currently being used, at least one method of authentication to be used for authenticating a user while the user performs the activity;
based on an interruption that prevents repeated authentication not exceeding the threshold amount of time, take at least a first action;
based on successful authentication resuming subsequent to the interruption but within the threshold amount of time, take at least a second action different from the first action; and
based on the interruption exceeding the threshold amount of time, take at least a third action different from the first and second actions.

2. The device of claim 1, wherein repeated authentication comprises continuous authentication.

3. The device of claim 1, wherein repeated authentication comprises periodic authentication.

4. The device of claim 1, wherein repeated authentication comprises periodic authentication at one or more regular time intervals.

5. The device of claim 1, wherein the instructions are executable to:
identify the threshold amount of time based on both the activity for which the device is currently being used and the method of authentication to be used for authenticating the user while the user performs the activity.

6. The device of claim 1, wherein the instructions are executable to:
identify the threshold amount of time based on the activity for which the device is currently being used and a security level associated with the activity.

7. The device of claim 1, wherein the first action comprises one or more of: refraining from providing a notification to a person regarding the interruption, accepting changes to data but not saving the changes to persistent storage as part of a current version of the data, accepting actions taken in relation to the data but not saving the actions to persistent storage, indicating the changes in a first log separate from the data, indicating the actions in a second log separate from the data.

8. The device of claim 7, wherein the interruption is a first interruption, and wherein the second action comprises one or more of: saving the changes to persistent storage as part of the current version of the data, saving the actions to persistent storage, indicating the first interruption in a third log separate from the data, determining whether a second interruption occurring subsequent to the first interruption exceeds the threshold amount of time.

9. The device of claim 8, wherein the third action comprises one or more of: prompting the user to authenticate themselves using a different method of authentication to save the changes, prompting the user to authenticate themselves using a different method of authentication to save the actions, locking the user out of the device and prompting the user to authenticate themselves using a different method of authentication to allow the user access to the device again, locking the user out of the data and prompting the user to authenticate themselves using a different method of authentication to allow the user access to the data again, indicating in a fourth log the first interruption as exceeding the threshold amount of time, performing another action that otherwise occurs based on authentication failure, marking the change as associated with authentication failure, marking the action as associated with authentication failure, providing the notification to the person regarding the first interruption, the person being different than the user.

10. The device of claim 9, wherein the instructions are executable to one or more of:
responsive to user authentication subsequent to performance of the third action and using the different mode of authentication, save the changes to persistent storage as part of the current version of the data;
responsive to user authentication subsequent to performance of the third action and using the different mode of authentication, save the actions to persistent storage.

11. The device of claim 1, wherein repeated authentication involves authenticating a user based on input other than a password associated with the user.

12. A method, comprising:
identifying a threshold amount of time, the identifying of the threshold amount of time being based on one or more of: an activity for which a device is currently being used, at least one mode of authentication to be used for authenticating a user while the user performs the activity;
based on an interruption that prevents repeated authentication not exceeding the threshold amount of time, taking at least a first action;
based on the interruption exceeding the threshold amount of time, taking at least a second action different from the first action.

13. The method of claim 12, comprising:
based on successful authentication resuming subsequent to the interruption but within the threshold amount of time, taking at least a third action different from the first and second actions.

14. The method of claim 13, wherein the interruption is a first interruption, and wherein the third action comprises one or more of: saving changes to data to persistent storage as part of a current version of the data, saving actions taken in relation to the data to persistent storage, indicating the first interruption in a log separate from the data, determining whether a second interruption occurring subsequent to the first interruption exceeds the threshold amount of time.

15. The method of claim 12, wherein the first action comprises one or more of: refraining from providing a notification to a person regarding the interruption, accepting changes to data but not saving the changes to persistent storage as part of a current version of the data, accepting actions taken in relation to the data but not saving the actions to persistent storage, indicating the changes in a first log separate from the data, indicating the actions in a second log separate from the data.

16. The method of claim 15, wherein the second action comprises one or more of: prompting the user to authenticate themselves using a different mode of authentication to save the changes, prompting the user to authenticate themselves using a different mode of authentication to save the actions, locking the user out of the device and prompting the user to authenticate themselves using a different mode of authentication to allow the user access to the device again, locking the user out of the data and prompting the user to authenticate themselves using a different mode of authentication to allow the user access to the data again, indicating in a fourth log the interruption as exceeding the threshold amount of time, performing another action that otherwise occurs based on authentication failure, marking the change as associated with authentication failure, marking the action as associated with authentication failure, providing the notification to the person regarding the interruption, the person being different than the user.

17. The method of claim 12, wherein the method comprises identifying the threshold amount of time based on both the activity for which the device is currently being used and the mode of authentication to be used for authenticating the user while the user performs the activity.

18. At least one computer readable storage medium (CRSM) that is not a transitory signal, the computer readable storage medium comprising instructions executable by at least one processor to:
identify a threshold amount of time, the identification of the threshold amount of time being based on an activity for which a device is currently being used and at least one method of authentication to be used for authenticating a user while the user performs the activity;
based on an interruption that prevents repeated authentication not exceeding the threshold amount of time, take at least a first action;
based on the interruption exceeding the threshold amount of time, take at least a second action different from the first action.

19. The CRSM of claim 18, wherein the instructions are executable to:
based on successful authentication resuming subsequent to the interruption but within the threshold amount of time, take at least a third action different from the first and second actions.

20. The CRSM of claim 18, wherein the first action involves reflecting changes to an electronic document on a display but not saving the changes to persistent storage as part of a current version of the electronic document, and wherein the second action involves reauthenticating the user to save the changes to persistent storage as part of the current version of the electronic document.
